(19) United States
(12) Patent Application Publication
(10) Pub. No.: US 2017/0053456 A1
(43) Pub. Date: Feb. 23, 2017

(54) METHOD AND APPARATUS FOR AUGMENTED-REALITY RENDERING ON MIRROR DISPLAY BASED ON MOTION OF AUGMENTED-REALITY TARGET

(71) Applicant: ELECTRONICS AND TELECOMMUNICATIONS RESEARCH INSTITUTE, Daejeon (KR)

(72) Inventors: Kyu-Sung CHO, Daejeon (KR); Ho-Won KIM, Seoul (KR); Tae-Joon KIM, Daejeon (KR); Ki-Nam KIM, Seoul (KR); Hye-Sun PARK, Daejeon (KR); Sung-Ryull SOHN, Daejeon (KR); Chang-Joon PARK, Daejeon (KR); Jin-Sung CHOI, Daejeon (KR)

(21) Appl. No.: 15/235,570

(22) Filed: Aug. 12, 2016

(30) Foreign Application Priority Data
Aug. 19, 2015 (KR) 10-2015-0116630

(51) Int. Cl. G06T 19/20; G06T 19/00; G06K 9/00; G06F 3/01; G06T 7/20

(52) U.S. Cl. CPC G06T 19/20; G06F 3/013; G06T 7/2033; G06K 9/00671; G06T 19/006; G06T 2207/20144; G06T 2210/16

(57) ABSTRACT

Method and apparatus for augmented-reality rendering on a mirror display based on motion of an augmented-reality target. The apparatus includes an image acquisition unit for acquiring a sensor image corresponding to at least one of a user and an augmented-reality target, a user viewpoint perception unit for acquiring coordinates of eyes of the user using the sensor image, an augmented-reality target recognition unit for recognizing an augmented-reality target, to which augmented reality is to be applied, a motion analysis unit for calculating a speed of motion corresponding to the augmented-reality target based on multiple frames, and a rendering unit for performing rendering by adjusting a transparency of virtual content to be applied to the augmented-reality target according to the speed of motion and by determining a position where the virtual content is to be rendered, based on the coordinates of the eyes.

### CROSS REFERENCE TO RELATED APPLICATION

This application claims the benefit of Korean Patent Application No. 10-2015-0116630, filed Aug. 19, 2015, which is hereby incorporated by reference in its entirety into this application.

### BACKGROUND OF THE INVENTION

1. Technical Field

The present invention generally relates to rendering technology for augmented reality and, more particularly, to technology for augmented-reality rendering on a mirror display based on the motion of an augmented-reality target, which can solve a mismatch attributable to the delay in displaying virtual content that inevitably occurs when augmented reality is applied to the mirror display.

2. Description of the Related Art

A mirror display or smart mirror is a display device which has the appearance of a mirror, but has a display attached to the rear surface of a semitransparent mirror, and is then configured to, when information is displayed on the display, show the information on the mirror. Since the visual experience of such mirror displays is new for users, the use of mirror displays has gradually increased in the advertising or fashion merchandising fields. In particular, in the fashion merchandising or advertising fields, a virtual clothes-fitting service may be regarded as the principal application of mirror displays. Virtual clothes-fitting technology is technology in which a user standing in front of a kiosk equipped with an image sensor is recognized, and virtual clothes or virtual accessories are graphically rendered on the physical region of the recognized user, thus helping the user determine whether the clothes or the accessories suit the user.

When conventional virtual clothes-fitting technology is implemented on a mirror display, a system delay inevitably occurs. That is, the shape of the user is reflected in the mirror at the speed of light, but the display of the rendered virtual clothes on the display is delayed until after the processing time required for image sensing, the processing time required for the recognition of user motion, the processing time required for the simulation of clothes, and the time required for the rendering of clothes has elapsed. During the delay time, the user may move, and thus a serious mismatch between the user's body and the rendered virtual clothes may be caused by the delay. The faster the user moves, the worse the mismatch, and thus the mismatch acts as a factor that interferes with the immersive clothes-fitting experience of the user.

Therefore, there is an urgent need to develop new rendering technology that detects the motion of the user, who is the target of augmented reality, and provides the effect of rendered virtual content, thus allowing the user to perceive the conventional problem and improving the immersive clothes-fitting experience of the user. In connection with this, Korean Patent Application Publication No. 10-2014-0128560 (Date of publication: Nov. 6, 2014) discloses a technology related to “A Method using An Interactive Mirror System based on Personal Purchase Information.”

### SUMMARY OF THE INVENTION

Accordingly, the present invention has been made keeping in mind the above problems occurring in the prior art, and an object of the present invention is to allow a user to perceive the problem of a mismatch caused by a system delay via a rendering effect, such as for transparency, thus inducing the user to more effectively use the corresponding service.

Another object of the present invention is to perform rendering by predicting the motion of the user, thus mitigating the degree of a mismatch, with the result that the immersion of the user in the service may be improved.

In accordance with an aspect of the present invention to accomplish the above objects, there is provided an apparatus for augmented-reality rendering on a mirror display based on motion of an augmented-reality target, including an image acquisition unit for acquiring a sensor image corresponding to at least one of a user and an augmented-reality target from at least one image sensor; a user viewpoint perception unit for acquiring coordinates of eyes of the user using the sensor image; an augmented-reality target recognition unit for recognizing an augmented-reality target, to which augmented reality is to be applied, using the sensor image; a motion analysis unit for calculating a speed of motion corresponding to the augmented-reality target based on multiple frames corresponding to the sensor image; and a rendering unit for performing rendering by adjusting a transparency of virtual content to be applied to the augmented-reality target according to the speed of motion and by determining a position at which the virtual content is to be rendered, based on the coordinates of the eyes.

The rendering unit performs rendering by adjusting the transparency to a higher value as an absolute value of the speed of motion is larger.

The rendering unit may be configured to set the transparency to 100% when the absolute value of the speed of motion is equal to or greater than a preset maximum speed, set the transparency to 0% when the absolute value of the speed of motion is less than or equal to a preset minimum speed, and linearly set the transparency to a value between 100% and 0% when the absolute value of the speed of motion is less than the preset maximum speed and is greater than the preset minimum speed.

The augmented-reality target recognition unit may separate a foreground and a background, and then recognize the augmented-reality target corresponding to a two-dimensional (2D) area using a recognition scheme corresponding to at least one of random forest, neural network, support vector machine, and AdaBoost schemes.

The motion analysis unit may calculate the speed of motion using variation in a central value representing the 2D area among the multiple frames.

The augmented-reality target recognition unit may recognize a three-dimensional (3D) posture of the augmented-reality target corresponding to at least one of a 3D position and an angle in the 2D area when the at least one image sensor is a depth sensor.

The motion analysis unit may calculate the speed of motion by combining at least one of variation and angular speed in the 3D position among the multiple frames.

The image acquisition unit may acquire the sensor image corresponding to at least one of an RGB image, a depth image, an infrared image, and a thermographic camera image, according to a type of the at least one image sensor.

The user viewpoint perception unit may acquire the coordinates of the eyes of the user by tracking pupils of the user in 3D space corresponding to the sensor image.

The user viewpoint perception unit may use coordinates corresponding to a head of the user instead of the coordinates of the eyes when it is impossible to track the pupils of the user.

The augmented-reality target may correspond to at least one of moving objects included in the sensor image.

The rendering unit may render the virtual content by adjusting at least one of blurring, a flashing effect, an image appearance effect, and a primary color distortion effect to correspond to the transparency.

The apparatus may further include a motion prediction unit for generating predicted motion by predicting subsequent motion of the augmented-reality target based on the multiple frames, wherein the rendering unit determines the position at which the virtual content is to be rendered so as to correspond to the predicted motion, thus rendering the virtual content.

In accordance with another aspect of the present invention to accomplish the above objects, there is provided a method for augmented-reality rendering on a mirror display based on motion of an augmented-reality target, including acquiring a sensor image corresponding to at least one of a user and an augmented-reality target from at least one image sensor; acquiring coordinates of eyes of the user using the sensor image; recognizing an augmented-reality target, to which augmented reality is to be applied, using the sensor image, and calculating a speed of motion corresponding to the augmented-reality target based on multiple frames corresponding to the sensor image; and performing rendering by adjusting a transparency of virtual content to be applied to the augmented-reality target according to the speed of motion and by determining a position at which the virtual content is to be rendered, based on the coordinates of the eyes.

Performing the rendering may include performing rendering by adjusting the transparency to a higher value as an absolute value of the speed of motion is larger.

Performing the rendering may be configured to set the transparency to 100% when the absolute value of the speed of motion is equal to or greater than a preset maximum speed, set the transparency to 0% when the absolute value of the speed of motion is less than or equal to a preset minimum speed, and linearly set the transparency to a value between 100% and 0% when the absolute value of the speed of motion is less than the preset maximum speed and is greater than the preset minimum speed.

Calculating the speed of motion may include separating a foreground and a background, and then recognizing the augmented-reality target corresponding to a two-dimensional (2D) area using a recognition scheme corresponding to at least one of random forest, neural network, support vector machine, and AdaBoost schemes.

Calculating the speed of motion may be configured to calculate the speed of motion using variation in a central value representing the 2D area among the multiple frames.

Calculating the speed may be configured to recognize a three-dimensional (3D) posture of the augmented-reality target corresponding to at least one of a 3D position and an angle in the 2D area when the at least one image sensor is a depth sensor.

Calculating the speed may be configured to calculate the speed of motion by combining at least one of variation and angular speed in the 3D position among the multiple frames.

Acquiring the sensor image may be configured to acquire the sensor image corresponding to at least one of an RUB image, a depth image, an infrared image, and a thermographic camera image, according to a type of the at least one image sensor.

Acquiring the coordinates of the eyes may be configured to acquire the coordinates of the eyes of the user by tracking pupils of the user in 3D space corresponding to the sensor image.

Acquiring the coordinates of the eyes may be configured to use coordinates corresponding to a head of the user instead of the coordinates of the eyes when it is impossible to track the pupils of the user.

The augmented-reality target may correspond to at least one of moving objects included in the sensor image.

Performing the rendering may be configured to render the virtual content by adjusting at least one of blurring, a flashing effect, an image appearance effect, and a primary color distortion effect to correspond to the transparency.

Acquiring the coordinates of the eyes may include acquiring the coordinates of the eyes of the user by tracking pupils of the user in 3D space corresponding to the sensor image; and using coordinates corresponding to a head of the user instead of the coordinates of the eyes when it is impossible to track the pupils of the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a virtual clothes-fitting system using an apparatus for augmented-reality rendering according to an embodiment of the present invention;

FIG. 2 is a block diagram showing an apparatus for augmented-reality rendering according to an embodiment of the present invention;

FIGS. 3 and 4 are diagrams showing examples of mirror-display technology;

FIG. 5 is a diagram showing an example of a virtual clothes-fitting service using mirror-display technology;

FIG. 6 is a diagram showing a virtual clothes-fitting service system using a conventional mirror display;

FIGS. 7 to 10 are diagrams showing examples of a virtual clothes-fitting service using an augmented-reality rendering method according to the present invention;

FIG. 11 is a diagram showing an example of a virtual clothes-fitting service in which the augmented-reality rendering method according to the present invention is applied to a transparent display;

FIG. 12 is a diagram showing an example in which the augmented-reality rendering method according to the present invention is applied to a see-through Head Mounted Display (HMD);

FIGS. 13 to 16 are block diagrams showing in detail the rendering unit shown in FIG. 2 depending on the rendering scheme; and

FIG. 17 is an operation flowchart showing a method for augmented-reality rendering on a mirror display based on the motion of an augmented-reality target according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the all to which the present invention pertains. Accordingly, the shapes, sizes, etc. of components in the drawings may be exaggerated to make the description clearer.

Hereinafter, preferred embodiments of the present invention will be described in detail with reference to the attached drawings.

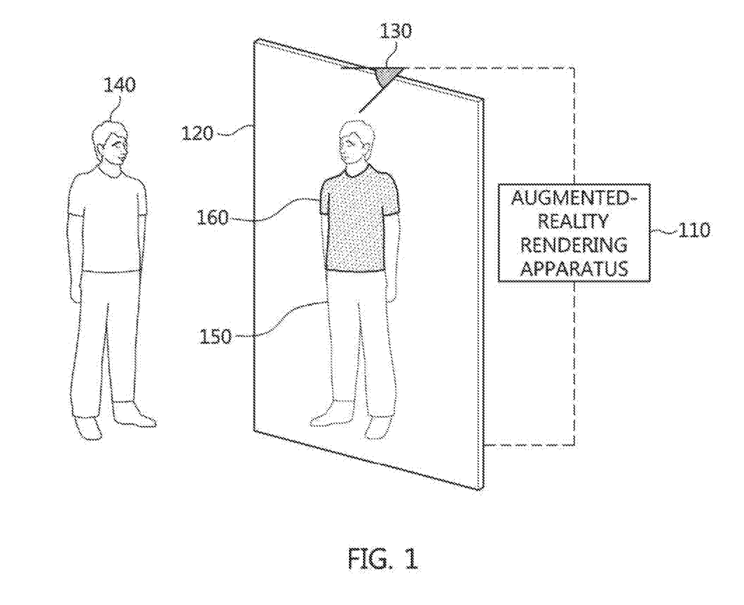

FIG. 1 is a diagram showing a virtual clothes-fitting system using an apparatus for augmented-reality rendering according to an embodiment of the present invention.

Referring to FIG. 1, the virtual clothes-fitting system according to the embodiment of the present invention may include an apparatus 110 for augmented-reality rendering (hereinafter also referred to as an “augmented-reality rendering apparatus 110”), a mirror display 120, an image sensor 130, a user 140, an augmented-reality target 150 reflected in a mirror, and virtual content 160.

The augmented-reality rendering apparatus 110 may analyze a sensor image input from the image sensor 130, perceive the viewpoint of the user 140 and the augmented-reality target, and calculate the speed of motion of the augmented-reality target. Further, when rendering is performed, the speed of motion may be reflected in the rendering.

Here, the present invention distinguishes the user 140 from the augmented-reality target, wherein the user 140 may be the person who views the virtual content 160 rendered on the augmented-reality target 150 reflected in the mirror via the mirror display 120. For example, in a virtual clothes-fitting service, when the user 140 himself or herself appreciates virtual clothes, that is, virtual content 160, fitted on his or her body, while viewing the mirror display 120, the user 140 himself or herself may be both the user 140 and the augmented-reality target. If user A appreciates virtual content 160 fitted on the body of user B in the state in which both users A and B are reflected in the mirror, user A may be the user 140 and user B may be the augmented-reality target,

Further, the augmented-reality target is not limited to a human being or an animal, but any object that moves may correspond to the target.

The mirror display 120 may be implemented such that a display panel is attached. to the rear surface of glass having reflectivity and transmissivity of a predetermined level or more in order to reflect externally input light and transmit light emitted from an internal display.

The image sensor 130 may be arranged around the mirror display 120 so as to perceive the viewpoint of the user 140 and recognize an augmented-reality target, which is intended to wear virtual clothes corresponding to the virtual content 160.

Further, the image sensor 130 may be one of at least one camera capable of capturing a color image, at least one depth sensor capable of measuring the distance to a subject, at least one infrared camera capable of capturing an infrared image, and at least one thermographic camera, or combinations thereof.

Furthermore, the image sensor 130 may be arranged either on the rear surface of the mirror display 120 or near the edge of the mirror display 120.

The virtual content 160 may be displayed on the mirror display 120 after a system delay. Here, the system delay may be the time required for the operation of the augmented-reality rendering apparatus 110. For example, the system delay may include the time required for image sensing, the time required to perceive the user's viewpoint, the time required to recognize the augmented-reality target, and the time required to render virtual clothes.

That is, if the augmented-reality target moves during the time corresponding to the system delay, the virtual content 160 may not be recognized as being precisely overlaid on the augmented-reality target 150 reflected in the mirror. Further, if the augmented-reality target does not move much, the performance of augmentation may seem satisfactory in spite of the presence of the system delay.

Therefore, the core content of the present invention is to calculate the speed at which the augmented-reality target moves, that is, the speed of motion thereof, and perform rendering so that, when the speed of motion is higher, a transparency effect is applied to the virtual content 160 when it is rendered, and when the speed of motion is lower, the virtual content 160 gradually becomes opaque, thus preventing any mismatch between the augmented-reality target 150 reflected in the mirror and the virtual content 160 from being easily visible to the user.

Therefore, according to the present invention, the user is reminded that, in order to clearly view the virtual content 160, the augmented-reality target must not move. That is, when virtual clothes corresponding to the virtual content 160 are shown as being transparent while the user 140 who is the augmented-reality target is changing his or her posture, the degree of a mismatch may be decreased, and the user 140 may be cognitively induced to keep still so as to view the fitted shape and the fitted color. This may be a solution to the problem of mismatch attributable to the system delay.

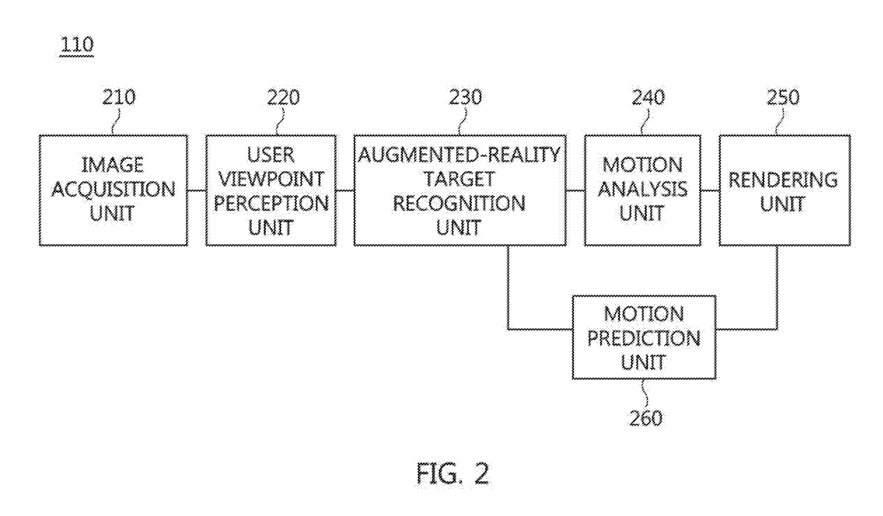

FIG. 2 is a block diagram showing an apparatus for augmented-reality rendering according to an embodiment of the present invention.

Referring to FIG. 2, the augmented-reality rendering apparatus 110 according to the embodiment of the present invention may include an image acquisition unit 210, a user viewpoint perception unit 220, an augmented-reality target recognition unit 230, a motion analysis unit 240, a rendering unit 250, and a motion prediction unit 260.

The image acquisition unit 210 may acquire a sensor image corresponding to at least one of a user and an augmented-reality target from at least one image sensor.

Here, depending on the type of the at least one image sensor, a sensor image corresponding to at least one of an RGB image, a depth image, an infrared image, and a thermographic camera image may be acquired.

Here, the augmented-reality target may be at least one moving object included in the sensor image. For example, a human being, an animal or a moving object may be the augmented-reality target.

The user viewpoint perception unit 220 may acquire the coordinates of the user's eyes using the sensor image.

Here, the coordinates of the eyes may be acquired by tracking the pupils of the user's eyes in the three-dimensional (3D) space corresponding to the sensor image. The coordinates of the user's eyes in the 3D space may be acquired from the sensor image using, for example, eye gaze tracking technology.

Here, if it is impossible to track the pupils of the user, the coordinates of the user's head may be used instead of the coordinates of the user's eyes. For example, when the distance between the user and the image sensor is too far and it is difficult to utilize eye gaze tracking technology for tracking the pupils, it is possible to track the user's head in 3D space, approximate the positions of eyes using the position of the head, and use the approximated positions of the eyes.

The coordinates of the eyes acquired in this way may be used to determine the position on the mirror display on which the virtual content is to be rendered

The augmented-reality target recognition unit 230 may recognize the augmented-reality target to which augmented reality is to be applied using the sensor image. Here, the recognition of the augmented-reality target may be realized using a method of separating a foreground and a background and recognizing the augmented-reality target using a learning device or a tracking device.

Here, as the method of separating the foreground and the background, a chroma-key technique based on colors, a background subtraction method, a depth-based foreground/background separation technique, or the like may be used.

In this case, after foreground/background separation has been performed, an augmented-reality target corresponding to a 2D area may be recognized using a recognition scheme corresponding to at least one of random forest, neural network, support vector machine, and AdaBoost schemes

In this case, when at least one image sensor is a depth sensor, the 3D posture of the augmented-reality target corresponding to at least one of the 3D position and angle in a 2D area may be recognized. Further, the 3D posture may be recognized even when the image sensor is calibrated,

Further, if the skeletal structure of the augmented-reality target is known in advance, 3D postures of respective joints constituting the skeleton may be more precisely recognized.

The motion analysis unit 240 may calculate the speed of motion of the augmented-reality target based on multiple frames corresponding to the sensor image. That is, the speed of motion may be calculated by aggregating pieces of information about the augmented-reality target respectively recognized in multiple frames.

Alternatively, the speed of motion may be calculated based on variation in a central value representing the 2D area among multiple frames. For example, the speed of motion may be calculated such that, in the augmented-reality target corresponding to the 2D area, a portion corresponding to the center of gravity is set as the central value, and variation in the central value is checked for each of the multiple frames

Alternatively, the speed of motion may be calculated by combining one or more of variation in 3D position and angular speed among the multiple frames.

Alternatively, when the skeletal structure of the augmented-reality target is recognized and the 3D positions and angles of all joints in the skeleton are acquired, the speed of motion may be calculated using the combination of average position variations and average angular speeds of all joints.

The rendering unit 250 may render the virtual content by adjusting the transparency of virtual content to be applied to the augmented-reality target according to the speed of motion and determining the position at which the virtual content is to be rendered based on the coordinates of the eyes.

Here, as the absolute value of the speed of motion increases, the transparency may be adjusted to a higher value, and rendering may then be performed based thereon. For example, in the case of a clothes-fitting service, the transparency of virtual clothes may be adjusted in proportion to the speed of motion.

In this case, when the absolute value of the speed of motion is equal to or greater than a preset maximum speed, the transparency is set to 100%, when the absolute value of the speed of motion is less than or equal to a preset minimum speed, the transparency is set to 0, and when the absolute value of the speed of motion is less than the preset maximum speed and greater than the preset minimum speed, the transparency may be linearly set to a value between 100% and 0%.

For example, assuming that the preset maximum speed is 0 and the preset minimum speed is t2, the transparency may be set to 100% when the absolute value of the speed of motion is equal to or greater than 0, and to 0% when the absolute value of the speed of motion is less than or equal to t2. Further, when the absolute value of the speed of motion is a value between t1 and t2, the transparency may be linearly set to a value between 100% and 0%.

That is, when the speed of motion is less than t2, so that that there is little motion, the transparency is 0%, and thus virtual content may be viewed to be opaque by the user's eyes. Further, as the speed of motion gradually increases, the transparency may be increased, and thus the virtual content may seem to become gradually less

Here, the method for associating transparency with speed may be implemented using various functions, in addition to a linear method. For example, a step function, an exponential function, or the like may be used.

Further, the position at which virtual content is to be rendered on the mirror display may be determined using the coordinates of the eyes in 3D space and the 3D position of the augmented-reality target.

In this case, the virtual content may be rendered by adjusting at least one of a blurring effect, a flashing effect, an image appearance effect, and a primary color distortion effect to correspond to the transparency. That is, the rendering method based on the speed of motion may be implemented using various methods in addition to transparency. For example, in the case of blurring, such as Gaussian blurring or motion blurring, when the speed of motion is higher, blurring is strongly realized, whereas when the speed of motion is lower, blurring may be weakly realized. Further, in the case of the flashing effect, when the speed of motion is higher, the content flashes at high speed, whereas when the speed of motion is lower, the content flashes at low speed, and then the flashing effect may disappear. Furthermore, in the case of the image appearance effect, when the speed of motion is higher, only the edge of the virtual content is visible, whereas when the speed of motion is gradually decreased, not only the edge but also the portion inside the edge is visible. Further, in the case of the primary color distortion effect, when the speed of motion is higher, the original colors are distorted to create a black-and-white effect, whereas when the speed of motion is gradually decreased, the original colors may be restored.

Further, at least one of transparency, blurring, the flashing effect, the image appearance effect, and the primary color distortion effect may be partially applied in association with the physical region of the user without being applied to the entire region of the virtual content. For example, instead of calculating the speed of motion using the central value of the augmented-reality target, a skeletal structure may be recognized, and all joints may be recognized. Thereafter, regions of the virtual content corresponding to respective joints are matched with the joints, and at least one of the transparency, blurring, flashing effect, image appearance effect, and primary color distortion effect may be applied to matching regions of the virtual content depending on the speed of motion of each joint.

At this time, the rendering position may be determined so as to correspond to predicted motion, after which the virtual content may be rendered. Even if the transparency, blurring, flashing effect, image appearance effect, or primary color distortion effect is applied to the virtual content depending on the speed of motion of the augmented-reality target, visual unnaturalness may occur when the difference between the positions of the virtual content and the augmented-reality target on the mirror display is great.

Therefore, if virtual content is rendered as close to the augmented-reality target as possible by predicting in advance the motion of the augmented-reality target, such mismatching may be reduced, and thus visual unnaturalness may also be minimized.

Accordingly, the motion prediction unit 260 may generate predicted motion by predicting subsequent motion of the augmented-reality target based on multiple frames. For example, a 3D posture corresponding to the predicted motion of the augmented-reality target during the time corresponding to a system delay may be predicted based on the motion of the augmented-reality target in multiple frames. Here, to predict a 3D posture, at least one of a uniform velocity model, a constant acceleration model, an Alpha-beta filter, a Kalman filter, and an extended Kalman filter may be used.

Therefore, when rendering is performed based on the predicted 3D posture, the degree of transparency or blurring may be set according to the speed of motion, thus enabling rendering to be performed.

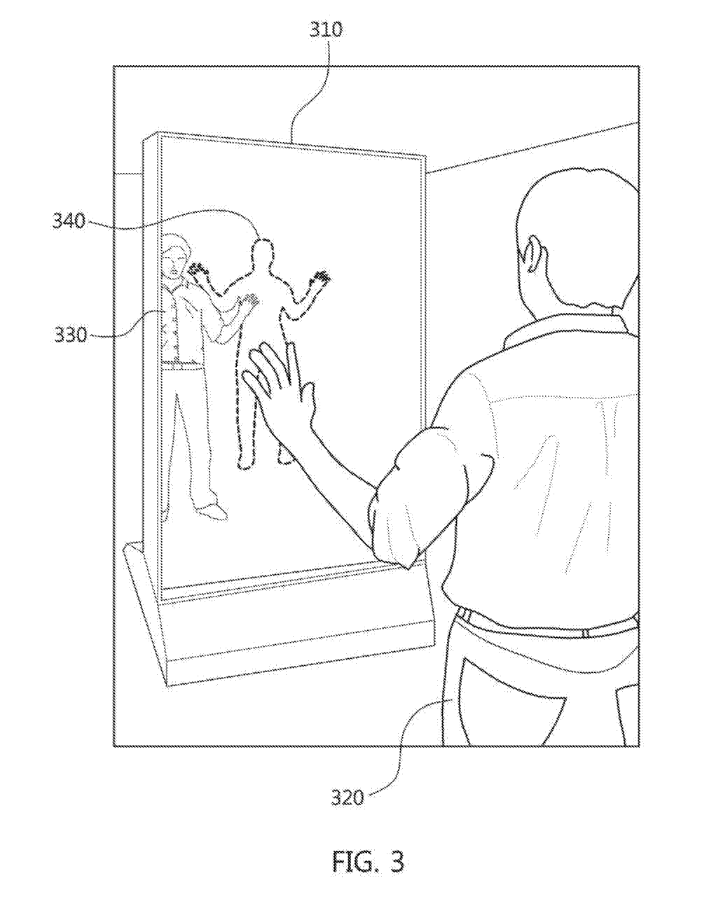

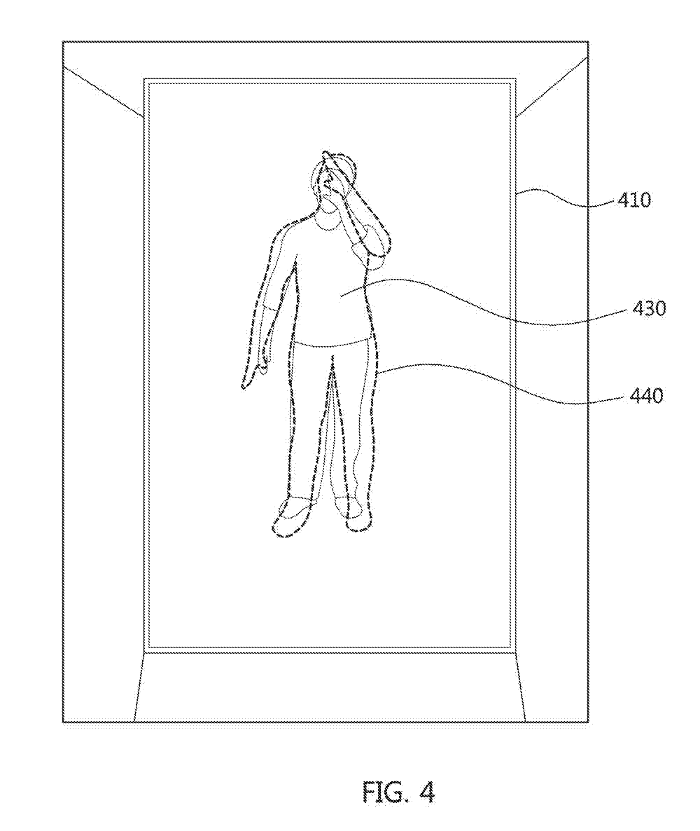

FIGS. 3 and 4 are diagrams showing an embodiment of mirror-display technology.

Referring to FIGS. 3 and 4, a mirror display 310 or a smart mirror has the appearance of a mirror, but has a display attached to the rear surface of a semitransparent mirror, and is configured to, when data is output via the display, show the data on the mirror.

For example, as shown in FIG. 3, when a user 320 stands in front of the mirror display 310 and looks at himself or herself reflected in the mirror display 310, the user 320, who is the target for which the mirror display 310 intends to output data corresponding to the augmented reality, may be the augmented-reality target. Here, the augmented-reality target may be the user 320 himself or herself, or may be another person or object.

Therefore, it can be seen in FIG. 3 that the mirror display 310 outputs a virtual augmented-reality target 340 as a kind of service provided via the mirror display 310 together with an augmented-reality target 330, which is reflected in the mirror and corresponds to the shape of the user 320.

For example, as shown in FIG. 4, the mirror display may recognize a region corresponding to the contour of an augmented-reality target 430 reflected in the mirror, and may then output the data representing a virtual augmented-reality target 440 using lines.

In this way, since the visual experience of technology using the mirror display 310 or 410 is new for users, there is a growing tendency to increase the use of the technology in the advertising or fashion merchandising fields.

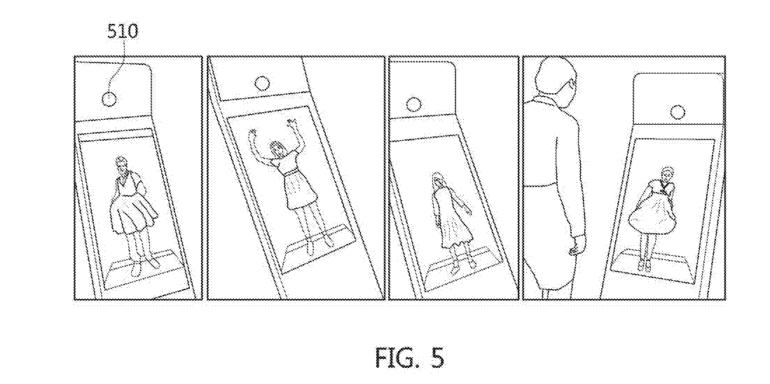

FIG. 5 is a diagram showing an example of a virtual clothes-fitting service using mirror-display technology.

Referring to FIG. 5, it can be seen that the virtual clothes-fitting service using mirror-display technology is used as a principal application in the advertising or fashion merchandising fields.

The term “virtual clothes-fitting service” or “virtual clothes-fitting technology” denotes technology in which a user standing in front of a kiosk equipped with an image sensor 510 is recognized, and an article of virtual clothing or a virtual accessory is graphically rendered and displayed in the physical region of the recognized user, thus helping the user determine whether the article of clothing or the accessory suits the user.

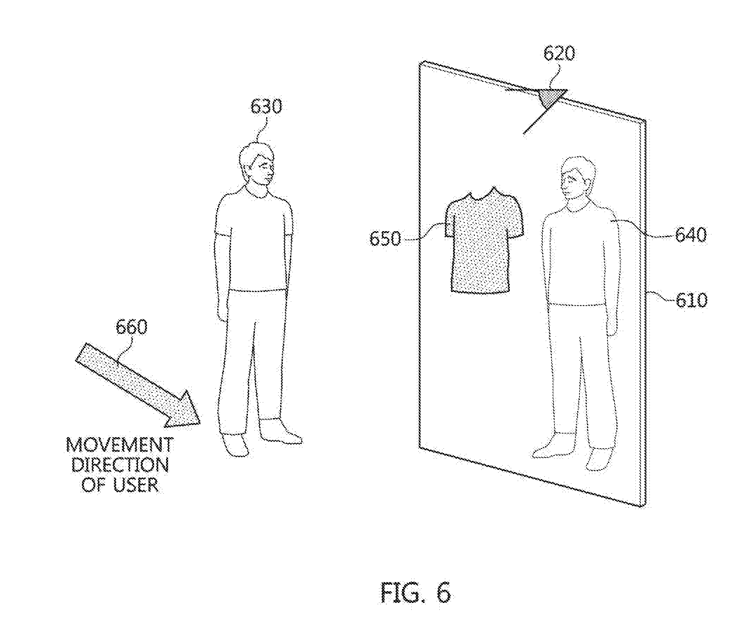

FIG. 6 is a diagram showing a virtual clothes-fitting service system using a conventional mirror display.

Referring to FIG. 6, the virtual clothes-fitting service system using a conventional mirror display 610 may cause a problem in that virtual content 650 does not match an augmented-reality target 640 reflected in the mirror due to an inevitable delay.

The reason for this problem is that the augmented-reality target 640 is reflected in the mirror at the speed of light, but the rendered virtual content 650 is delayed and output via the mirror display 610 after the processing time required for image sensing, the processing time required for the recognition of user motion, the processing time required for the simulation of clothes, and the processing time required for rendering of clothing have elapsed.

Here, since the user 630 corresponding to the augmented-reality target may move during the delay in rendering the piece of clothing corresponding to the virtual content 650, a mismatch between the augmented-reality target 640 reflected in the mirror and the virtual content 650 is inevitably caused due to the delay time.

This mismatch phenomenon may be more serious in the case in which the user 630 moves faster, and this may act as a factor interfering with immersion of the user 630, provided with the virtual clothes-fitting service via the mirror display 610, in the virtual clothes-fitting experience.

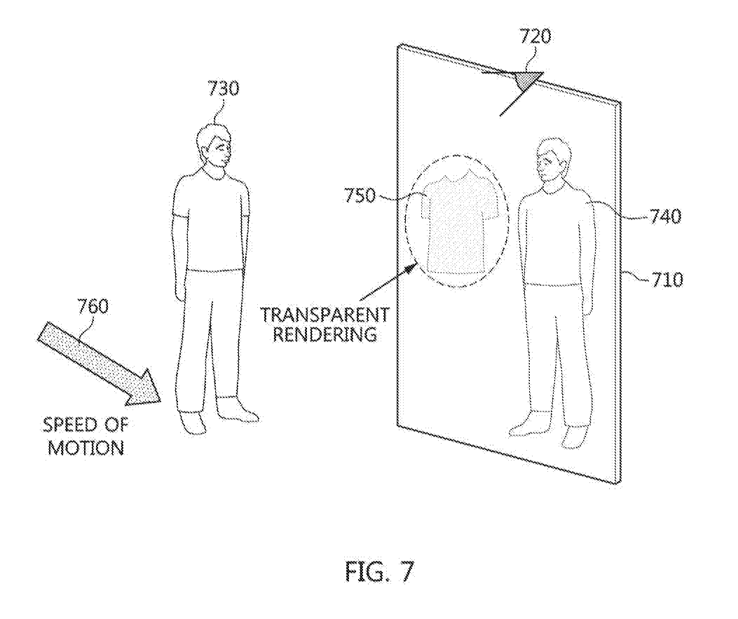

FIGS. 7 to 10 are diagrams showing examples of a virtual clothes-fitting service using the augmented-reality rendering method according to the present invention.

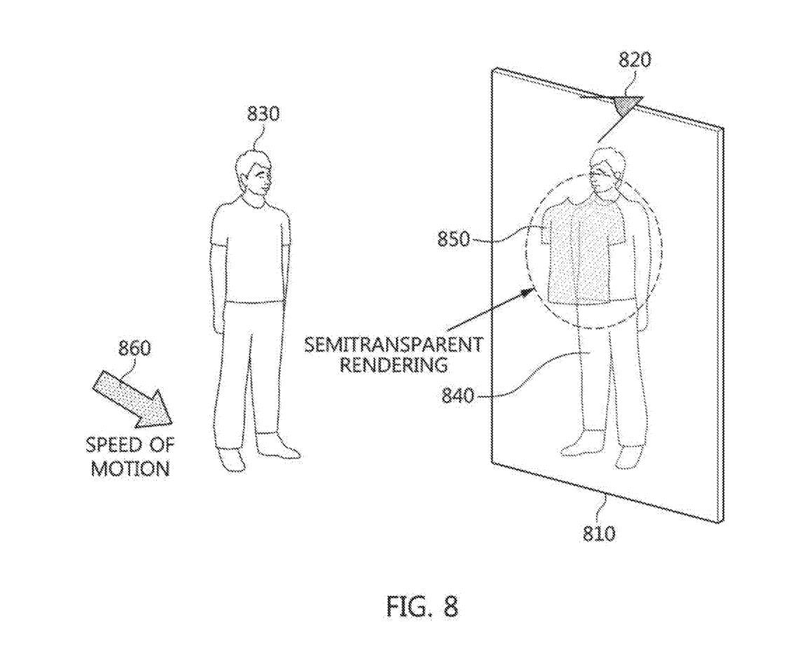

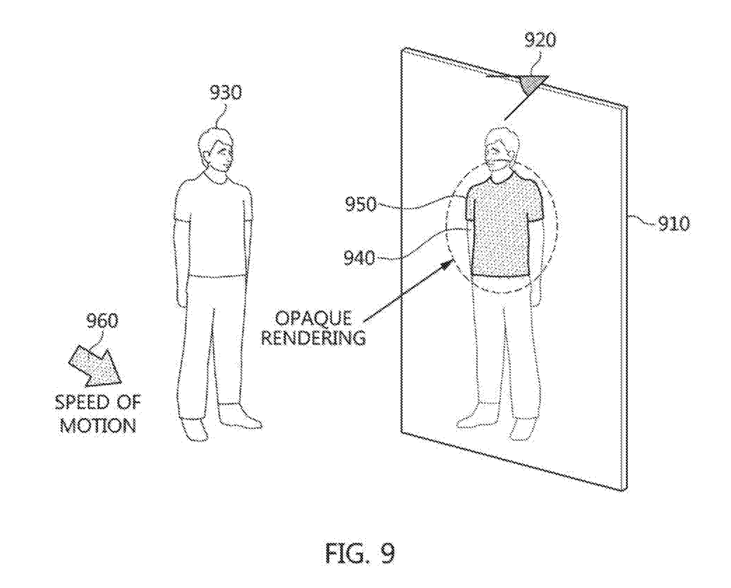

Referring to FIGS. 7 to 9, the speed of motion of the user who is the augmented-reality target is calculated. When the speed of motion 760 is higher, as shown in FIG. 7, rendering may be performed by applying a transparency effect to virtual content 750 when rendering the virtual content 750. In this case, as shown in FIGS. 8 and 9, when the speed of motion 860 or 960 is decreased, virtual content 850 or 950 may be gradually rendered to be opaque.

Therefore, as shown in FIG. 7, when the speed of motion 760 is higher, and the mismatch between the virtual content 750 and the augmented-reality target 740 reflected in the mirror is great, the visual content is rendered to be transparent, thus preventing the mismatch from being readily visible to the eyes of a user 730.

Further, the effect of reminding a user 930, who is the augmented-reality target, that the user 930 himself or herself should not move may be expected in order to enable the virtual content 950 to be clearly viewed based on the transparency effect, as shown in FIG. 9.

That is, when the user 930 shown in FIG. 9 changes his or her posture again, the virtual content 950 is transparently viewed during the change of the posture, so that unnaturalness attributable to mismatching may be reduced while the user 930 views the virtual content 950. Thus, the user 930 is induced to keep still, thus enabling the virtual content 950 to be clearly rendered while matching augmented-reality target 940.

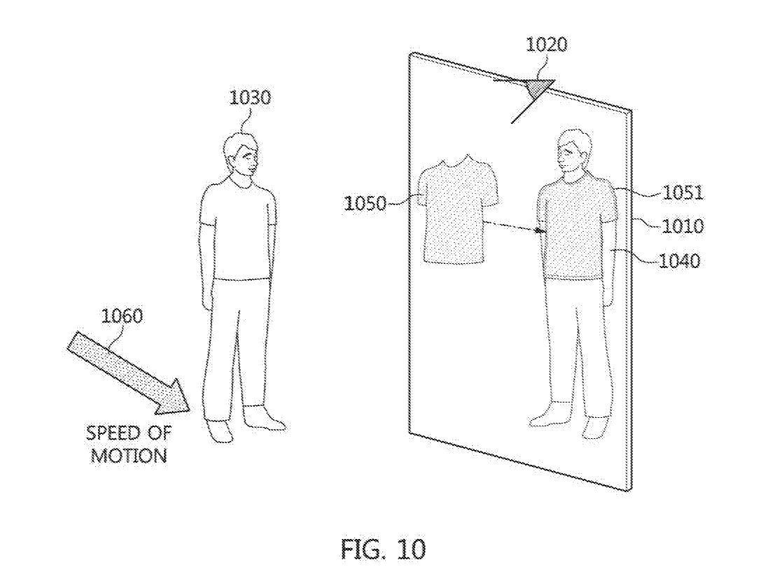

Further, referring to FIG. 10, the motion of a user 1030, who is the augmented-reality target, is predicted during the time corresponding to the system delay, and thus predicted virtual content 1051 in which a mismatch is reduced may be generated.

For original virtual content 1050 rendered using the method shown in FIG. 7 or 9, the rendered position deviates greatly from the position at which the augmented-reality target is reflected in the mirror. Accordingly, even if a transparency or blurring effect is applied to rendering, visual unnaturalness may still remain.

Therefore, if the motion of the augmented-reality target is predicted, and predicted virtual content 1051 is rendered at the position closest to that of the augmented-reality target 1040 reflected in the mirror, the degree of mismatch may be reduced, and thus unnaturalness may also be reduced when the user 1030 views the mirror display 1010.

In this regard, to predict the 3D posture of the augmented-reality target, at least one of a uniform velocity model, a constant acceleration model, an Alpha-Beta filter, a Kalman filter, and an extended Kalman filter may be used.

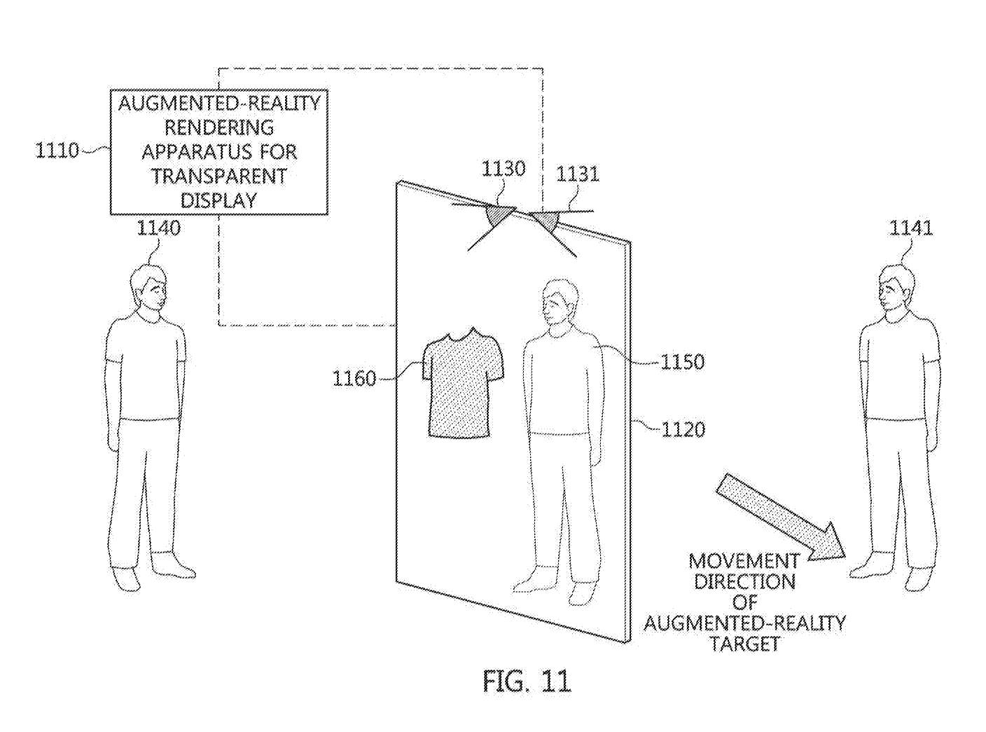

FIG. 11 is a diagram showing an example of a virtual clothes-fitting service in which the augmented-reality rendering method according to the present invention is applied to a transparent display.

Referring to FIG. 11, even in conventional transparent display technology, the problem of mismatch between an augmented-reality target and virtual content may occur, similar to the case of mirror-display technology.

That is, when a user 1140 views content via a transparent display 1120, an augmented-reality target 1150, viewed via the transparent display, is displayed at the speed of light, but virtual content 1160 may be rendered on the transparent display 1120 after the system delay of the augmented-reality rendering apparatus 1110 for the transparent display has elapsed. Therefore, when the augmented-reality target 1141 moves during the time corresponding to the system delay, mismatching between the virtual content 1160 and the augmented-reality target 1141 may occur.

The hardware configuration required to solve this mismatching problem may be almost the same as the configuration using the mirror display according to the present invention shown in FIG. 1.

For example, the mirror display is replaced with the transparent display 1120. The sensor direction of the image sensor faces the front of the mirror display in FIG. 1, but a front image sensor 1130, facing the front of the transparent display 1120, and a rear image sensor 1131, facing the rear of the transparent display 1120, may be provided in FIG. 11. Further, the augmented-reality rendering apparatus 1110 for the transparent display may be almost the same as the augmented-reality rendering apparatus shown in FIG. 1. However, there may be only a difference in that, when the viewpoint of the user is perceived, a sensor image acquired through the front image sensor 1130 is used, and when the augmented-reality target is recognized, a sensor image acquired through the rear image sensor 1131 is used.

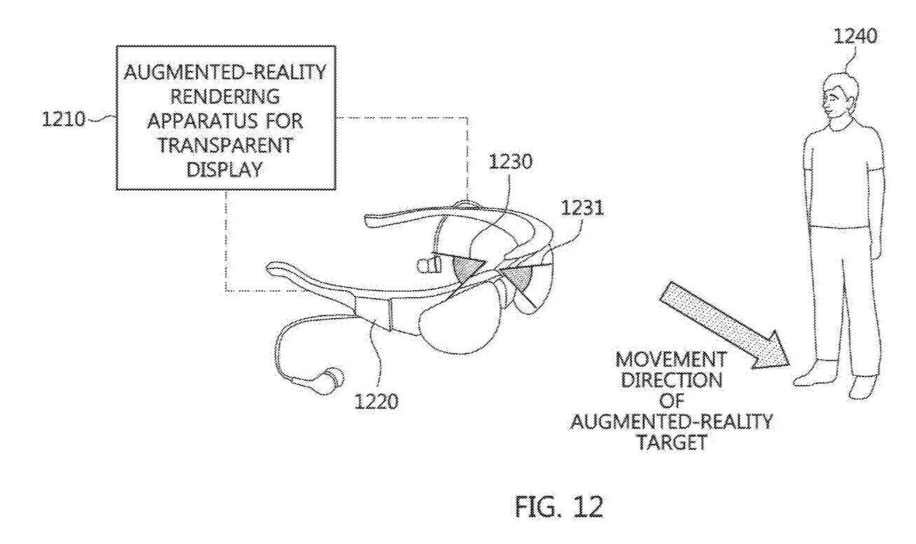

FIG. 12 is a diagram showing an example in which the augmented-reality rendering method according to the present invention is applied to a see-through Head Mounted Display (HMD).

Referring to FIG. 12, a mismatch problem appearing in the transparent display technology may occur even in service that uses a see-through HMD 1220.

Therefore, this mismatch problem may be solved by respectively mounting a front image sensor 1230 and a rear image sensor 1231 on the front surface and the rear surface of the see-through HMD 1220, as shown in FIG. 12, and by utilizing the augmented-reality rendering apparatus 1210 for the transparent display, which is identical to the transparent display augmented-reality rendering apparatus of FIG. 11.

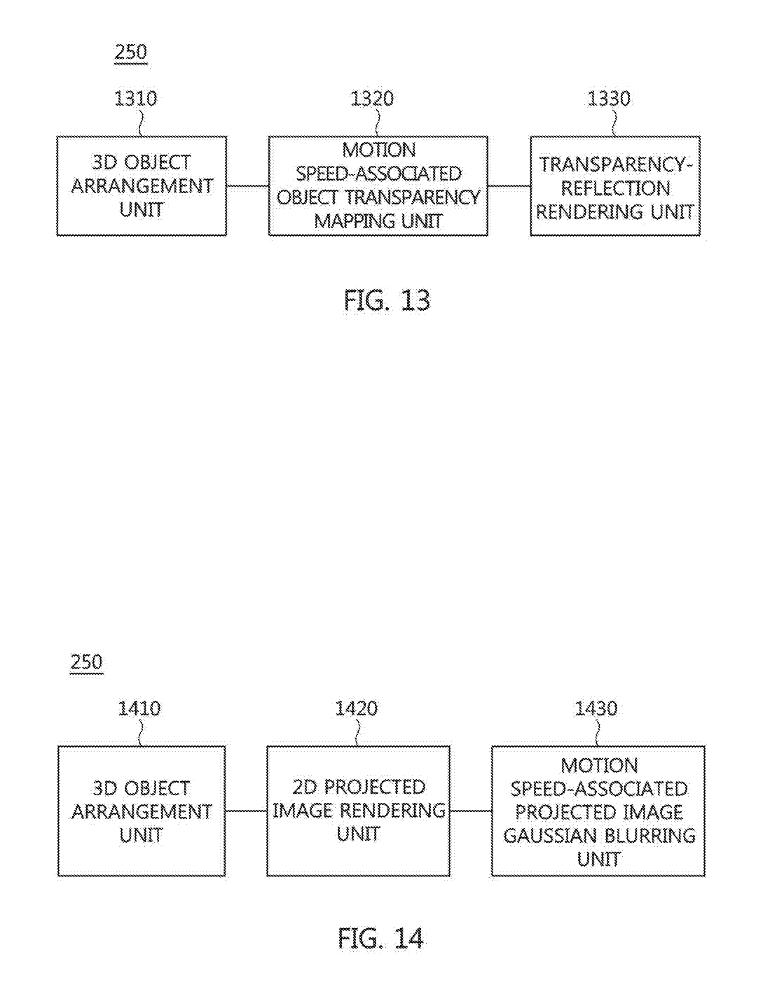

FIGS. 13 to 16 are block diagrams showing in detail the rendering unit shown in FIG. 2 depending on the rendering scheme.

Referring to FIGS. 13 to 16, FIG. 13 may illustrate a rendering unit 250 using a transparency scheme.

The rendering unit 250 may include a 3D object arrangement unit 1310, a motion speed-associated object transparency mapping unit 1320, and a transparency-reflection rendering unit 1330.

Here, the 3D object arrangement unit 1310 may be configured to arrange a 3D object using the 3D position of an augmented-reality target mapped to the real world, and to arrange a virtual rendering camera based on the positions of the eyes in 3D space.

Thereafter, the transparency attribute of a 3D object, that is, an alpha value, is assigned to the speed of motion of the 3D object in association with the speed of motion using the motion speed-associated object transparency mapping unit 1320, after which rendering may be performed using the transparency-reflection rendering unit 1330.

FIG. 14 may illustrate a rendering unit 250 using a Gaussian blurring scheme.

Here, the rendering unit 250 may include a 3D object arrangement unit 1410, a 2D projected image rendering unit 1420, and a motion speed-associated projected image Gaussian blurring unit 1430.

The 3D object arrangement unit 1410 may be operated in the same manner as the 3D object arrangement unit 1310 shown in FIG. 13, and thus a detailed description thereof will be omitted.

Here, after a 3D object and a virtual camera have been arranged, a 2D projected image of an augmented-reality target may be acquired by performing rendering using the 2D projected image rendering unit 1420.

Thereafter, the Gaussian blurring unit 1430 may apply a 2D Gaussian filter to the projected image.

Here, when the speed increases, the Gaussian filter may greatly increase a Gaussian distribution (sigma) in response to the increased speed, whereas when the speed decreases, the Gaussian filter may decrease the Gaussian distribution. That is, when the Gaussian distribution becomes larger, the effect of blurring the image may become stronger.

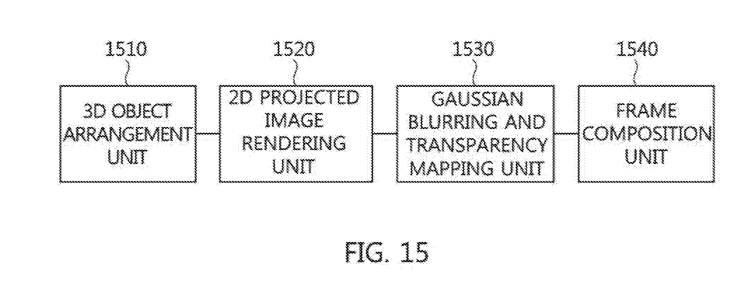

FIG. 15 may illustrate a rendering unit 250 using a motion blurring scheme.

Here, the rendering unit 250 may include a 3D object arrangement unit 1510, a 2D projected image rendering unit 1520, a Gaussian blurring and transparency mapping unit 1530, and a frame composition unit 1540.

Here, since the 3D object arrangement unit 1510 and the 2D projected image rendering unit 1520 may be operated in the same manner as the 3D object arrangement unit 1410 and the 2D projected image rendering unit 1420 shown in FIG. 14, a detailed description thereof will be omitted.

Here, the Gaussian blurring and transparency mapping unit 1530 may generate an image by combining projected images of N previous frames.

The images may be combined after applying the strongest blurring to the oldest projected image and the weakest blurring to the latest projected image.

Alternatively, the images may be combined after applying the highest transparency to the oldest projected image and the lowest transparency to the latest projected image.

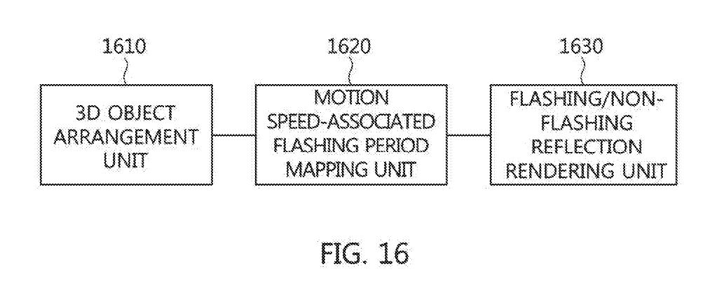

FIG. 16 may illustrate a rendering unit 250 using a flashing scheme.

Here, the rendering unit 250 may include a 3D object arrangement unit 1610, a motion speed-associated flashing period mapping unit 1620, and a flashing/non-flashing reflection rendering unit 1630.

The 3D object arrangement unit 1610 may be operated in the same manner as the 3D object arrangement unit 1510 shown in FIG. 15, and thus a detailed description thereof will be omitted.

Here, a flashing period may be set in association with the speed of motion using the motion speed-associated flashing period mapping unit 1620. For example, when the speed is high, the flashing period may be set to a shorter period, whereas when the speed is low, the flashing period may be set to a longer period,

Here, the flashing/non-flashing reflection rendering unit 1630 may represent the flashing effect using a method of rendering or not rendering an object on the screen based on the flashing period,

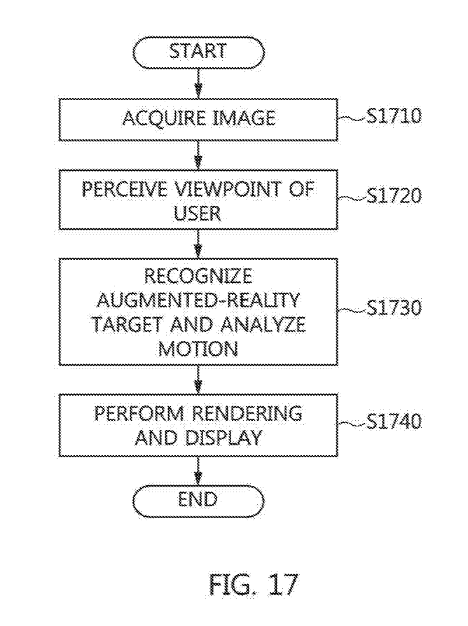

FIG. 17 is an operation flowchart showing a method for augmented-reality rendering on a mirror display based on the motion of an augmented-reality target according to an embodiment of the present invention.

Referring to FIG. 17, the method for augmented-reality rendering on a mirror display based on the motion of an augmented-reality target according to the embodiment of the present invention may acquire a sensor image corresponding to at least one of a user and an augmented-reality target from at least one image sensor at step S1710.

Here, depending on the type of the at least one image sensor, a sensor image corresponding to at least one of an RGB image, a depth image, an infrared image, and a thermographic camera image may be acquired.

Further, the augmented-reality target may be at least one moving object included in the sensor image. For example, a human being, an animal or a moving object may be the augmented-reality target.

Further, the method for augmented-reality rendering on a mirror display based on the motion of the augmented-reality target according to the embodiment of the present invention may acquire the coordinates of the user's eyes using the sensor image at step S1720.

Here, the coordinates of the eyes may be acquired by tracking the pupils of the user's eyes in the three-dimensional (3D) space corresponding to the sensor image. The coordinates of the user's eyes in the 3D space may be acquired from the sensor image using, for example, eye gaze tracking technology.

if it is impossible to track the pupils of the user, the coordinates of the user's head may be used instead of the coordinates of the user's eyes. For example, when the distance between the user and the image sensor is too far and it is difficult to utilize eye gaze tracking technology for tracking the pupils, it is possible to track the user's head in 3D space, approximate the positions of eyes using the position of the head, and use the approximated positions of the eyes.

The coordinates of the eyes acquired in this way may be used to determine the position on the mirror display on which the virtual content is to be rendered.

Next, the method for augmented-reality rendering on a mirror display based on the motion of the augmented-reality target according to the embodiment of the present invention may recognize the augmented-reality target to which augmented reality is to be applied using the sensor image, and may calculate the speed of motion of the augmented-reality target based on multiple frames corresponding to the sensor image at step S1730.

Here, the recognition of the augmented-reality target may be implemented using a recognition method based on a learning device or a tracking device after separating a foreground and a background.

As the method of separating the foreground and the background, a chroma-key technique based on colors, a background subtraction method, a depth-based foreground/background separation technique, or the like may be used.

In this case, after foreground/background separation has been performed, an augmented-reality target corresponding to a 2D area may be recognized using a recognition scheme corresponding to at least one of random forest, neural network, support vector machine, and AdaBoost schemes.

In this case, when at least one image sensor is a depth sensor, the 3D posture of the augmented-reality target corresponding to at least one of the 3D position and angle in a 2D area may be recognized. Further, the 3D posture may be recognized even when the image sensor is calibrated.

Further, if the skeletal structure of the augmented-reality target is known in advance, 3D postures of respective joints constituting the skeleton may be more precisely recognized.

Here, the speed of motion may be calculated based on variation in a central value representing the 2D area among multiple frames. For example, the speed of motion may be calculated such that, in the augmented-reality target corresponding to the 2D area, a portion corresponding to the center of gravity is set as the central value, and variation in the central value is checked for each of the multiple frames.

Alternatively, the speed of motion may be calculated by combining one or more of variation in 3D position and angular speed among the multiple frames.

Alternatively, when the skeletal structure of the augmented-reality target is recognized and the 3D positions and angles of all joints in the skeleton are acquired, the speed of motion may be calculated using the combination of average position variations and average angular speeds of all joints.

Further, the method for augmented-reality rendering on a mirror display based on the motion of the augmented-reality target according to the embodiment of the present invention may adjust the transparency of virtual content to be applied to the augmented-reality target according to the speed of motion, and may determine the position at which the virtual content is to be rendered based on the coordinates of the eyes, thus performing rendering, at step S1740.

Here, as the absolute value of the speed of motion increases, the transparency may be adjusted to a higher value, and rendering may then be performed based thereon. For example, in the case of a clothes-fitting service, the transparency of virtual clothes may be adjusted in proportion to the speed of motion.

In this case, when the absolute value of the speed of motion is equal to or greater than a preset maximum speed, the transparency is set to 100%, when the absolute value of the speed of motion is less than or equal to a preset minimum speed, the transparency is set to 0, and when the absolute value of the speed of motion is less than the preset maximum speed and greater than the preset minimum speed, the transparency may be linearly set to a value between 100% and 0%,

For example, assuming that the preset maximum speed is t1 and the preset minimum speed is t2, the transparency may be set to 100% when the absolute value of the speed of motion is equal to or greater than t1, and to 0% when the absolute value of the speed of motion is less than or equal to t2. Further, when the absolute value of the speed of motion is a value between t1 and t2, the transparency may be linearly set to a value between 100% and 0%.

That is, when the speed of motion is less than t2, so that that there is little motion, the transparency is 0%, and thus virtual content may be viewed to be opaque by the user's eyes, Further, as the speed of motion gradually increases, the transparency may be increased, and thus the virtual content may seem to become gradually less visible.

Here, the method for associating transparency with speed may be implemented using various functions, in addition to a linear method. For example, a step function, an exponential function, or the like may be used.

Further, the position at which virtual content is to be rendered on the mirror display may be determined using the coordinates of the eyes in 3D space and the 3D position of the augmented-reality target.

In this case, the virtual content may be rendered by adjusting at least one of a blurring effect, a flashing effect, an image appearance effect, and a primary color distortion effect to correspond to the transparency. That is, the rendering method based on the speed of motion may be implemented using various methods in addition to transparency. For example, in the case of blurring, such as Gaussian blurring or motion blurring, when the speed of motion is higher, blurring is strongly realized, whereas when the speed of motion is lower, blurring may be weakly realized. Further, in the case of the flashing effect, when the speed of motion is higher, the content flashes at high speed, whereas when the speed of motion is lower, the content flashes at low speed, and then the flashing effect may disappear. Furthermore, in the case of the image appearance effect, when the speed of motion is higher, only the edge of the virtual content is visible, whereas when the speed of motion is gradually decreased, not only the edge but also the portion inside the edge is visible. Further, in the case of the primary color distortion effect, when the speed of motion is higher, the original colors are distorted to create a black-and-white effect, whereas when the speed of motion is gradually decreased, the original colors may be restored.

Further, at least one of transparency, blurring, the flashing effect, the image appearance effect, and the primary color distortion effect may be partially applied in association with the physical region of the user without being applied to the entire region of the virtual content. For example, instead of calculating the speed of motion using the central value of the augmented-reality target, a skeletal structure may be recognized, and all joints may be recognized. Thereafter, regions of the virtual content corresponding to respective joints are matched with the joints, and at least one of the transparency, blurring, flashing effect, image appearance effect, and primary color distortion effect may be applied to matching regions of the virtual content depending on the speed of motion of each joint.

At this time, the rendering position may be determined so as to correspond to predicted motion, after which the virtual content may be rendered. Even if the transparency, blurring, flashing effect, image appearance effect, or primary color distortion effect is applied to the virtual content depending on the speed of motion of the augmented-reality target, visual unnaturalness may occur when the difference between the positions of the virtual content and the augmented-reality target on the mirror display is great.

Therefore, if virtual content is rendered as close to the augmented-reality target as possible by predicting in advance the motion of the augmented-reality target, such mismatching may be reduced, and thus visual unnaturalness may also be minimized.

Accordingly, although not shown in FIG. 17, the method for augmented-reality rendering on a mirror display based on the motion of the augmented-reality target according to the embodiment of the present invention may generate predicted motion by predicting the subsequent motion of the augmented-reality target based on multiple frames. For example, the 3D posture corresponding to the predicted motion of the augmented-reality target during the time corresponding to the system delay may be predicted based on the motion of the augmented-reality target in the multiple frames. Here, to predict the 3D posture, at least one of a uniform velocity model, a constant acceleration model, an Alpha-Beta filter, a Kalman filter, and an extended Kalman filter may be used.

Therefore, when rendering is performed based on the predicted 3D posture, rendering may be performed by setting the degree of transparency or blurring according to the speed of motion.

In accordance with the present invention, a user may perceive the problem of a mismatch caused by a system delay via a rendering effect, such as for transparency, thus inducing the user to more effectively use the corresponding service.

Further, the present invention may perform rendering by predicting the motion of the user, thus mitigating the degree of a mismatch, with the result that the immersion of the user in the service may be improved.

As described above, in the method and apparatus for augmented-reality rendering on a mirror display based on the motion of an augmented-reality target according to the present invention, the configurations and schemes in the above-described embodiments are not limitedly applied, and some or all of the above embodiments can be selectively combined and configured so that various modifications are possible.

What is claimed is:

1. An apparatus for augmented-reality rendering on a mirror display based on motion of an augmented-reality target, comprising:
an image acquisition unit for acquiring a sensor image corresponding to at least one of a user and an augmented-reality target from at least one image sensor;
a user viewpoint perception unit for acquiring coordinates of eyes of the user using the sensor image;
an augmented-reality target recognition unit for recognizing an augmented-reality target, to which augmented reality is to be applied, using the sensor image;
a motion analysis unit for calculating a speed of motion corresponding to the augmented-reality target based on multiple frames corresponding to the sensor image; and
a rendering unit for performing rendering by adjusting a transparency of virtual content to be applied to the augmented-reality target according to the speed of motion and by determining a position at which the virtual content is to be rendered, based on the coordinates of the eyes.

2. The apparatus of claim 1, wherein the rendering unit performs rendering by adjusting the transparency to a higher value as an absolute value of the speed of motion is larger.

3. The apparatus of claim 1, wherein the rendering unit is configured to set the transparency to 100% when the absolute value of the speed of motion is equal to or greater than a preset maximum speed, set the transparency to 0% when the absolute value of the speed of motion is less than or equal to a preset minimum speed, and linearly set the transparency to a value between 100% and 0% when the absolute value of the speed of motion is less than the preset maximum speed and is greater than the preset minimum speed.

4. The apparatus of claim 1, wherein the augmented-reality target recognition unit separates a foreground and a background, and then recognizes the augmented-reality target corresponding to a two-dimensional (2D) area using a recognition scheme corresponding to at least one of random forest, neural network, support vector machine, and AdaBoost schemes.

5. The apparatus of claim 4, wherein the motion analysis unit calculates the speed of motion using variation in a central value representing the 2D area among the multiple frames.

6. The apparatus of claim 4, wherein the augmented-reality target recognition unit recognizes a three-dimensional (3D) posture of the augmented-reality target corresponding to at least one of a 3D position and an angle in the 2D area when the at least one image sensor is a depth sensor.

7. The apparatus of claim 6, wherein the motion analysis unit calculates the speed of motion by combining at least one of variation and angular speed in the 3D position among the multiple frames.

8. The apparatus of claim 5, wherein the image acquisition unit acquires the sensor image corresponding to at least one of an RGB image, a depth image, an infrared image, and a thermographic camera image, according to a type of the at least one image sensor.

9. The apparatus of claim 1, wherein the user viewpoint perception unit acquires the coordinates of the eyes of the user by tracking pupils of the user in 3D space corresponding to the sensor image.

10. The apparatus of claim 9, wherein the user viewpoint perception unit uses coordinates corresponding to a head of the user instead of the coordinates of the eyes when it is impossible to track the pupils of the user.

11. The apparatus of claim 1, wherein the augmented-reality target corresponds to at least one of moving objects included in the sensor image.

12. The apparatus of claim 1, wherein the rendering unit renders the virtual content by adjusting at least one of blurring, a flashing effect, an image appearance effect, and a primary color distortion effect to correspond to the transparency.

13. The apparatus of claim 1, further comprising a motion prediction unit for generating predicted motion by predicting subsequent motion of the augmented-reality target based on the multiple frames,
wherein the rendering unit determines the position at which the virtual content is to be rendered so as to correspond to the predicted motion, thus rendering the virtual content.

14. A method for augmented-reality rendering on a mirror display based on motion of an augmented-reality target, comprising:
acquiring a sensor image corresponding to at least one of a user and an augmented-reality target from at least one image sensor;
acquiring coordinates of eyes of the user using the sensor image;
recognizing an augmented-reality target, to which augmented reality is to be applied, using the sensor image, and calculating a speed of motion corresponding to the augmented-reality target based on multiple frames corresponding to the sensor image; and
performing rendering by adjusting a transparency of virtual content to be applied to the augmented-reality target according to the speed of motion and by determining a position at which the virtual content is to be rendered, based on the coordinates of the eyes.

15. The method of claim 14, wherein performing the rendering comprises performing rendering by adjusting the transparency to a higher value as an absolute value of the speed of motion is larger.

16. The method of claim 15, wherein performing the rendering is configured to set the transparency to 100% when the absolute value of the speed of motion is equal to or greater than a preset maximum speed, set the transparency to 0% when the absolute value of the speed of motion is less than or equal to a preset minimum speed, and linearly set the transparency to a value between 100% and 0% when the absolute value of the speed of motion is less than the preset maximum speed and is greater than the preset minimum speed.

17. The method of claim 15, wherein calculating the speed of motion comprises:
separating a foreground and a background, and then recognizing the augmented-reality target corresponding to a two-dimensional (2D) area using a recognition scheme corresponding to at least one of random forest, neural network, support vector machine, and AdaBoost schemes.

18. The method of claim 17, wherein calculating the speed of motion is configured to calculate the speed of motion using variation in a central value representing the 2D area among the multiple frames.

19. The method of claim 18, wherein acquiring the sensor image comprises:
acquiring the sensor image corresponding to at least one of an RGB image, a depth image, an infrared image, and a thermographic camera image, according to a type of the at least one image sensor.

20. The method of claim 14, wherein acquiring the coordinates of the eyes comprises:
acquiring the coordinates of the eyes of the user by tracking pupils of the user in 3D space corresponding to the sensor image; and
using coordinates corresponding to a head of the user instead of the coordinates of the eyes when it is impossible to track the pupils of the user.
